(19) United States
(12) Patent Application Publication
(10) Pub. No.: US 2022/0329971 A1
(43) Pub. Date: Oct. 13, 2022

(54) DETERMINING CONTEXT CATEGORIZATIONS BASED ON AUDIO SAMPLES

(71) Applicant: HERE Global B.V., Eindhoven (NL)

(72) Inventors: Henri Jaakko Julius Nurminen, Tampere (FI); Pavel Ivanov, Tampere (FI); Marko Luomi, Lempaeaelae (FI)

(21) Appl. No.: 17/301,304

(22) Filed: Mar. 31, 2021

(51) Int. Cl. H04W 4/02; G06N 20/00; G06K 9/62; G06N 3/04; G10L 19/008

(52) U.S. Cl. CPC H04W 4/025; G06N 20/00; G06K 9/6278; G06N 3/04; G10L 19/008

(57) ABSTRACT

A processor obtains an audio sample captured by an audio sensor of a mobile device. The processor determines a context categorization for the mobile device based at least one the audio sample. The context categorization comprises at least one motion state and a vehicle indicator corresponding to a context experienced by the mobile device when the audio sample was captured. Determining the context categorization comprises analyzing the audio sample using a classification engine. The processor provides the context categorization for the mobile device as input to a crowd-sourcing or positioning process.

### TECHNOLOGICAL FIELD

An example embodiment relates to determining a context categorization for a mobile device based on an audio sample captured by an audio sensor physically associated with the mobile device. An example embodiment relates to using a context categorization determined based on an audio sample as input to a crowd-sourcing or positioning process.

### BACKGROUND

In various scenarios, the motion state of a mobile device may be used to trigger different actions by the mobile device. For example, execution of a fitness application, provision of mobile advertising, or triggering of crowd-sourced measurement collections by the mobile device may be triggered based on a motion state of the mobile device. Inertial measurement unit (IMU) sensors (e.g., accelerometers, gyroscopes) provide reliable step detection, which may be used as input for motion state and vehicle type detection. However, IMU measurements alone are insufficient in a number of scenarios. For example, it is difficult or impossible to distinguish between a person being still (e.g., sitting, standing) and not in a vehicle and a person who is being still (e.g., sitting, standing) and in a vehicle, even when the vehicle is moving. Moreover, IMU sensors may detect steps when a person is riding a bicycle or moving inside of a train, for example. So the detection of steps by IMU sensors does not necessarily mean that the person is walking and not in a vehicle. Use of global navigation satellite system (GNSS) based measurements can overcome some of the shortcomings of IMU-based detection. However, there may be various restrictions on GNSS usage based on battery consumption and privacy restrictions. Additionally, reliable GNSS-based measurements are not always available (e.g., indoors, in parking garages, in urban canyons, inside a train, and/or the like) and may remain unavailable for a significant period of time.

### BRIEF SUMMARY

Various embodiments provide methods, apparatus, systems, and computer program products for determining a context categorization for a mobile device based on an audio sample captured by one or more audio sensors of the mobile device. An audio sensor of the mobile device is in communication with a processor of the mobile device and is co-located with the mobile device such that sounds captured, detected, and/or the like by an audio sensor of the mobile device are sounds in the environment about the mobile device. In various embodiments, a context categorization comprises at least one motion state and a vehicle type. In various embodiments, the at least one motion state comprises a user motion state describing user motion of a user associated with the mobile device and/or a vehicle motion state describing motion of a vehicle that the mobile device is associated with (e.g., onboard, physically coupled to, and/or the like). In various embodiments, the vehicle type indicates a type of vehicle that the mobile device is associated with (e.g., onboard, physically coupled to, and/or the like).

For example, in an example embodiment, the type of vehicle is selected from the group comprising no vehicle/pedestrian, bicycle, motorbike, golf cart, passenger car, truck, bus, train, subway, airplane, boat, and/or the like. In an example embodiment, the user motion state is selected from the group comprising still, walking, or running. In an example embodiment, the vehicle motion state is selected from the group comprising still, moving at a low speed that is less than a low speed threshold, moving at a moderate speed that is in a range between the low speed threshold and a high speed threshold, moving at a high speed, that is greater than the high speed threshold. In an example embodiment, the low speed and high speed thresholds are vehicle type specific.

In various embodiments, a classification engine is trained to determine and/or estimate a context categorization for a mobile device based on processing, analyzing, and/or the like an audio sample captured by an audio sample that is physically associated with the mobile device. In various embodiments, the classification engine is a machine learning trained model and/or processing engine configured to determine and/or estimate a context categorization corresponding to an audio sample. In various embodiments, the classification engine is trained using a plurality of audio samples that are each labeled with a respective context categorization corresponding to the context under which the audio sample was captured. For example, the classification engine is trained using a supervised machine learning technique, in an example embodiment. For example, classification engine is trained such that when an audio sample is provided to an input layer of the classification engine (e.g., via an application program interface (API) call and/or the like), the classification engine processes the audio sample via the hidden layers of the classification engine, and a determined and/or estimated context categorization corresponding to the audio sample is provided via an output layer of the classification engine.

In an example embodiment, a processor obtains an audio sample captured by an audio sensor of a mobile device. The processor determines a context categorization for the mobile device based at least on the audio sample. The context categorization for the mobile device comprises at least one motion state and a vehicle type indicator. Determining the context categorization for mobile device comprises analyzing the audio sample using a classification engine. The processor provides the context classification for the mobile device as input to a crowd-sourcing or positioning process.

In an example embodiment, a processor obtains a plurality of audio samples. Each audio sample corresponds to a respective context categorization and is associated with a respective label indicating the respective context categorization. The respective context categorization comprises at least one motion state and a vehicle type indicator. The processor uses a machine learning technique and the plurality of audio samples to train a classification engine to determine a context categorization based on analyzing an audio sample. In an example embodiment, the processor provides the classification engine (e.g., parameters and/or architecture information corresponding to the trained classification engine) such that a mobile device receives the classification engine. The mobile device is configured to use the classification engine to analyze a first audio sample to determine a first context categorization. In an example embodiment, the processor obtains the first audio sample, determines the first context categorization by analyzing the first audio sample using the classification engine, and provides an indication of the first context categorization.

In one aspect of the present disclosure, a method for determining a context categorization and using the context categorization to perform a crowd-sourcing and/or positioning function and/or task. In an example embodiment, the method comprises obtaining, by a processor, an audio sample captured by an audio sensor of a mobile device. The method further comprises determining, by the processor, a context categorization for the mobile device based at least on the audio sample. The context categorization comprises at least one motion state and a vehicle type indicator. Determining the context categorization comprises analyzing the audio sample using a classification engine. The method further comprises providing, by the processor, the context categorization for the mobile device as input to a crowd-sourcing or positioning process.

In an example embodiment, the audio sample is captured by the mobile device responsive to a trigger condition being satisfied. In an example embodiment, the trigger condition is satisfied when at least one of the following occurs—(a) one or more sensor measurements captured by sensors of the mobile device indicate that GNSS-based measurements are not available; (b) the context categorization cannot be determined based on inertial sensors; (c) one or more sensor measurements captured by sensors of the mobile device indicate that one or more crowd-sourcing criteria are satisfied; (d) one or more sensor measurements captured by sensors of the mobile device indicate that a particular radio device is detected at at least a threshold signal strength for at least a threshold amount of time; or (e) an indoor positioning estimate is to be performed. In an example embodiment, the processor is one of (a) part of the mobile device, (b) part of a server, or (c) part of a cloud-based processing network. In an example embodiment, one or more parameters of the classification engine were determined using a supervised machine learning process. In an example embodiment, the classification engine is a machine learning trained engine and training data used to train the classification engine comprises a plurality of audio samples associated with corresponding context categorization labels.

In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

In an example embodiment, the crowd-sourcing or positioning process is a mobile access point identification process, the mobile access point identification process is configured to responsive to determining that one or more observations of an access point by the mobile device satisfy one or more observation criteria and the context categorization for the mobile device comprises a vehicle motion state indicating a vehicle that the mobile device is associate with is moving, determine that the access point is a mobile access point; and cause an access point registry to be updated to indicate that the access point is a mobile access point. In an example embodiment, the method further comprises responsive to determining the one or more observations of the access point by the mobile device satisfy one or more observation criteria, causing the capturing of the audio sample to be triggered.

In an example embodiment, the crowd-sourcing or positioning process is configured to determine a position estimate for the mobile device and determine one or more parameters to be used in determining the position estimate for the mobile device based at least in part on the context categorization for the mobile device. In an example embodiment, the crowd-sourcing or positioning process is configured to determine whether to cause the mobile device to capture and/or provide crowd-sourced information based at least in part on the context categorization for the mobile device. In an example embodiment, the crowd-sourcing or positioning process is configured to generate an indoor positioning map based at least in part on crowd-sourced information captured by one or more sensors of the mobile device. In an example embodiment, the crowd-sourcing or positioning process is configured to determine a user movement pattern for at least one type of vehicle based on crowd-sourced information captured by one or more sensors of the mobile device. In an example embodiment, the classification engine is one of a k-nearest neighbor classifier, a linear classifier, a Bayesian classifier, a decision tree, or a neural network.

According to another aspect of the present disclosure, an apparatus is provided. In an example embodiment, the apparatus comprises at least one processor and at least one memory storing computer program code and/or instructions. The at least one memory and the computer program code and/or instructions are configured to, with the processor, cause the apparatus to at least obtain an audio sample captured by an audio sensor of a mobile device; determine a context categorization for the mobile device based at least on the audio sample; and provide the context categorization for the mobile device as input to a crowd-sourcing or positioning process. The context categorization comprises at least one motion state and a vehicle type indicator. Determining the context categorization comprises analyzing the audio sample using a classification engine.

In an example embodiment, the audio sample is captured by the mobile device responsive to a trigger condition being satisfied. In an example embodiment, the trigger condition is satisfied when at least one of the following occurs—(a) one or more sensor measurements captured by sensors of the mobile device indicate that GNSS-based measurements are not available; (b) the context categorization cannot be determined based on inertial sensors; (c) one or more sensor measurements captured by sensors of the mobile device indicate that one or more crowd-sourcing criteria are satisfied; (d) one or more sensor measurements captured by sensors of the mobile device indicate that a particular radio device is detected at at least a threshold signal strength for at least a threshold amount of time; or (e) an indoor positioning estimate is to be performed. In an example embodiment, the apparatus is one of (a) the mobile device, (b) a server, or (c) part of a cloud-based processing network. In an example embodiment, one or more parameters of the classification engine were determined using a supervised machine learning process. In an example embodiment, the classification engine is a machine learning trained engine and training data used to train the classification engine comprises a plurality of audio samples associated with corresponding context categorization labels.

In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

In an example embodiment, the crowd-sourcing or positioning process is a mobile access point identification process, the mobile access point identification process is configured to responsive to determining that one or more observations of an access point by the mobile device satisfy one or more observation criteria and the context categorization for the mobile device comprises a vehicle motion state indicating a vehicle that the mobile device is associate with is moving, determine that the access point is a mobile access point; and cause an access point registry to be updated to indicate that the access point is a mobile access point. In an example embodiment, the at least one memory and the computer program code and/or instructions are further configured to, with the processor, cause the apparatus to at least, responsive to determining the one or more observations of the access point by the mobile device satisfy one or more observation criteria, causing the capturing of the audio sample to be triggered.

In an example embodiment, the crowd-sourcing or positioning process is configured to determine a position estimate for the mobile device and determine one or more parameters to be used in determining the position estimate for the mobile device based at least in part on the context categorization for the mobile device. In an example embodiment, the crowd-sourcing or positioning process is configured to determine whether to cause the mobile device to capture and/or provide crowd-sourced information based at least in part on the context categorization for the mobile device. In an example embodiment, the crowd-sourcing or positioning process is configured to generate an indoor positioning map based at least in part on crowd-sourced information captured by one or more sensors of the mobile device. In an example embodiment, the crowd-sourcing or positioning process is configured to determine a user movement pattern for at least one type of vehicle based on crowd-sourced information captured by one or more sensors of the mobile device. In an example embodiment, the classification engine is one of a k-nearest neighbor classifier, a linear classifier, a Bayesian classifier, a decision tree, or a neural network.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to obtain an audio sample captured by an audio sensor of a mobile device; determine a context categorization for the mobile device based at least on the audio sample; and provide the context categorization for the mobile device as input to a crowd-sourcing or positioning process. The context categorization comprises at least one motion state and a vehicle type indicator. Determining the context categorization comprises analyzing the audio sample using a classification engine.

In an example embodiment, the audio sample is captured by the mobile device responsive to a trigger condition being satisfied. In an example embodiment, the trigger condition is satisfied when at least one of the following occurs—(a) one or more sensor measurements captured by sensors of the mobile device indicate that GNSS-based measurements are not available; (b) the context categorization cannot be determined based on inertial sensors; (c) one or more sensor measurements captured by sensors of the mobile device indicate that one or more crowd-sourcing criteria are satisfied; (d) one or more sensor measurements captured by sensors of the mobile device indicate that a particular radio device is detected at at least a threshold signal strength for at least a threshold amount of time; or (e) an indoor positioning estimate is to be performed. In an example embodiment, the apparatus is one of (a) the mobile device, (b) a server, or (c) part of a cloud-based processing network. In an example embodiment, one or more parameters of the classification engine were determined using a supervised machine learning process. In an example embodiment, the classification engine is a machine learning trained engine and training data used to train the classification engine comprises a plurality of audio samples associated with corresponding context categorization labels.

In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

In an example embodiment, the crowd-sourcing or positioning process is a mobile access point identification process, the mobile access point identification process is configured to responsive to determining that one or more observations of an access point by the mobile device satisfy one or more observation criteria and the context categorization for the mobile device comprises a vehicle motion state indicating a vehicle that the mobile device is associate with is moving, determine that the access point is a mobile access point; and cause an access point registry to be updated to indicate that the access point is a mobile access point. In an example embodiment, the computer-readable program code and/or instructions portions comprise executable portions further configured, when executed by the processor of the apparatus, to cause the apparatus to, responsive to determining the one or more observations of the access point by the mobile device satisfy one or more observation criteria, causing the capturing of the audio sample to be triggered.

In an example embodiment, the crowd-sourcing or positioning process is configured to determine a position estimate for the mobile device and determine one or more parameters to be used in determining the position estimate for the mobile device based at least in part on the context categorization for the mobile device. In an example embodiment, the crowd-sourcing or positioning process is configured to determine whether to cause the mobile device to capture and/or provide crowd-sourced information based at least in part on the context categorization for the mobile device. In an example embodiment, the crowd-sourcing or positioning process is configured to generate an indoor positioning map based at least in part on crowd-sourced information captured by one or more sensors of the mobile device. In an example embodiment, the crowd-sourcing or positioning process is configured to determine a user movement pattern for at least one type of vehicle based on crowd-sourced information captured by one or more sensors of the mobile device. In an example embodiment, the classification engine is one of a k-nearest neighbor classifier, a linear classifier, a Bayesian classifier, a decision tree, or a neural network.

According to yet another aspect, an apparatus is provided. In an example embodiment, the apparatus comprises obtaining an audio sample captured by an audio sensor of a mobile device. The apparatus comprises means for determining a context categorization for the mobile device based at least on the audio sample. The context categorization comprises at least one motion state and a vehicle type indicator. Determining the context categorization comprises analyzing the audio sample using a classification engine. The apparatus comprises means for providing the context categorization for the mobile device as input to a crowd-sourcing or positioning process.

According to another aspect of the present disclosure, a method for preparing and/or generating a classification engine is provided. In an example embodiment, the method comprises obtaining, by a processor, a plurality of audio samples. Each audio sample corresponds to a respective context categorization and is associated with a respective label indicating the respective context categorization. The respective context categorization comprises at least one motion state and a vehicle type indicator. The method further comprises training, by the processor, a classification engine, using a supervised machine learning technique and the plurality of audio samples, to determine a context categorization based on analyzing an audio sample. The method further comprises at least one of (a) providing, by the processor, the classification engine such that a mobile device receives the classification engine, the mobile device configured to use the classification engine to analyze a first audio sample to determine a first context categorization, or (b) obtaining, by the processor, the first audio sample, determining the first context categorization by analyzing the first audio sample using the classification engine, and providing an indication of the first context categorization.

In an example embodiment, the classification engine is one of a k-nearest neighbor classifier, a linear classifier, a Bayesian classifier, a decision tree, or a neural network. In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

According to another aspect of the present disclosure, an apparatus is provided. In an example embodiment, the apparatus comprises at least one processor and at least one memory storing computer program code and/or instructions. The at least one memory and the computer program code and/or instructions are configured to, with the processor, cause the apparatus to at least obtain a plurality of audio samples; training, by the processor, a classification engine, using a supervised machine learning technique and the plurality of audio samples, to determine a context categorization based on analyzing an audio sample; and at least one of (a) providing, by the processor, the classification engine such that a mobile device receives the classification engine, the mobile device configured to use the classification engine to analyze a first audio sample to determine a first context categorization, or (b) obtaining, by the processor, the first audio sample, determining the first context categorization by analyzing the first audio sample using the classification engine, and providing an indication of the first context categorization. Each audio sample corresponds to a respective context categorization and is associated with a respective label indicating the respective context categorization. The respective context categorization comprises at least one motion state and a vehicle type indicator.

In an example embodiment, the classification engine is one of a k-nearest neighbor classifier, a linear classifier, a Bayesian classifier, a decision tree, or a neural network. In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to obtain a plurality of audio samples; training, by the processor, a classification engine, using a supervised machine learning technique and the plurality of audio samples, to determine a context categorization based on analyzing an audio sample; and at least one of (a) providing, by the processor, the classification engine such that a mobile device receives the classification engine, the mobile device configured to use the classification engine to analyze a first audio sample to determine a first context categorization, or (b) obtaining, by the processor, the first audio sample, determining the first context categorization by analyzing the first audio sample using the classification engine, and providing an indication of the first context categorization. Each audio sample corresponds to a respective context categorization and is associated with a respective label indicating the respective context categorization. The respective context categorization comprises at least one motion state and a vehicle type indicator.

In an example embodiment, the classification engine is one of a k-nearest neighbor classifier, a linear classifier, a Bayesian classifier, a decision tree, or a neural network. In an example embodiment, the at least one motion state comprises at least one of (a) a user motion state describing user motion of a user associated with the mobile device or (b) a vehicle motion state indicating a vehicle motion of a vehicle associated with the mobile device. In an example embodiment, the vehicle type indicator is configured to indicate a type of a vehicle with which the mobile device is associated.

According to yet another aspect, an apparatus is provided. For example, the apparatus comprises means for obtaining a plurality of audio samples. Each audio sample corresponds to a respective context categorization and is associated with a respective label indicating the respective context categorization. The respective context categorization comprises at least one motion state and a vehicle type indicator. The apparatus comprises means for training a classification engine, using a supervised machine learning technique and the plurality of audio samples, to determine a context categorization based on analyzing an audio sample. The apparatus comprises means for at least one of (a) providing the classification engine such that a mobile device receives the classification engine, the mobile device configured to use the classification engine to analyze a first audio sample to determine a first context categorization, or (b) obtaining the first audio sample, determining the first context categorization by analyzing the first audio sample using the classification engine, and providing an indication of the first context categorization.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a network device that may be specifically configured in accordance with an example embodiment;

FIG. 2B is a block diagram of a mobile device that may be specifically configured in accordance with an example embodiment;

FIG. 3 is a flowchart illustrating operations performed, such as by the network device of FIG. 2A, in accordance with an example embodiment;

FIG. 4 is a flowchart illustrating operations performed, such as by the network device of FIG. 2A or the mobile device of FIG. 2B, in accordance with an example embodiment; and

FIG. 5 is a flowchart illustrating operations performed, such as by the mobile device of FIG. 2B, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Methods, apparatus, systems, and computer program products for determining a context categorization for a mobile device based on an audio sample captured by one or more audio sensors of the mobile device. An audio sensor of the mobile device is in communication with a processor of the mobile device and is co-located with the mobile device such that sounds captured, detected, and/or the like by an audio sensor of the mobile device are sounds in the environment about the mobile device. In various embodiments, a context categorization comprises at least one motion state and a vehicle type. In various embodiments, the at least one motion state comprises a user motion state describing user motion of a user associated with the mobile device and/or a vehicle motion state describing motion of a vehicle that the mobile device is associated with (e.g., onboard, physically coupled to, and/or the like). In various embodiments, the vehicle type indicates a type of vehicle that the mobile device is associated with (e.g., onboard, physically coupled to, and/or the like).

For example, in an example embodiment, the type of vehicle is selected from the group comprising no vehicle/pedestrian, bicycle, motorbike, golf cart, passenger car, truck, bus, train, subway, airplane, boat, and/or the like. In an example embodiment, the motion state of the mobile device is selected from the group comprising still, walking, or running. In an example embodiment, the vehicle motion state is selected from the group comprising still, moving at a low speed that is less than a low speed threshold, moving at a moderate speed that is in a range between the low speed threshold and a high speed threshold, moving at a high speed, that is greater than the high speed threshold. In an example embodiment, the low speed and high speed thresholds are vehicle type specific. For example, the low speed threshold may be 20 miles per hour, 25 miles per hour, 30 miles per hour, 30 kilometers per hour, 40 kilometers per hour, 50 kilometers per hour, and/or the like, in various embodiments. For example, the high speed threshold may be 50 miles per hour, 55 miles per hour, 60 miles per hour, 80 kilometers per hour, 90 kilometers per hour, 100 kilometers per hour, and/or the like, in various embodiments. In an example embodiment, the above-referenced high speed and low speed thresholds correspond to vehicle types corresponding to motorized vehicles and the low and/or high speed threshold for vehicle types corresponding to non-motorized vehicles are lower. In an example embodiment, the high speed and low speed thresholds are used for each vehicle type (possibly other than no vehicle/pedestrian).

In various embodiments, a classification engine is trained to determine and/or estimate a context categorization for a mobile device based on processing, analyzing, and/or the like an audio sample captured by an audio sample that is physically associated with the mobile device. In various embodiments, the classification engine is a machine learning trained model and/or processing engine configured to determine and/or estimate a context categorization corresponding to an audio sample. In various embodiments, the classification engine is trained using a plurality of audio samples that are each labeled with a respective context categorization corresponding to the context under which the audio sample was captured. For example, the classification engine is trained using a supervised machine learning technique, in an example embodiment. For example, classification engine is trained such that when an audio sample is provided to an input layer of the classification engine (e.g., via an application program interface (API) call and/or the like), the classification engine processes the audio sample via the hidden layers of the classification engine, and a determined and/or estimated context categorization corresponding to the audio sample is provided via an output layer of the classification engine.

In various embodiments, the classification engine is one of a k-nearest neighbor classifier, a linear classifier, a Bayesian classifier, a decision tree, or a neural network. For example, the classification engine comprises and/or is defined by an architecture and one or more parameters corresponding to the architecture. For example, the classification comprises an input layer, input node(s), and/or the like configured for receiving an audio sample and provide the received audio sample as input to the classification engine. The classification further comprises one or more intermediate layers, hidden layers, processing layers, and/or the like configured to process, analyze, transform, convert, and/or the like the audio same into a determination and/or estimation of a context categorization that is provided via an output layer, output node(s), and/or the like. For example, the classification engine comprises an output layer, output node(s), and/or the like configured for providing a determined and/or estimated context categorization as output of the classification engine.

In various embodiments, the crowd-sourcing or positioning process is a mobile access point identification process. In various embodiments, a mobile access point is a network access point (e.g., Wi-Fi network; cellular network such as 5G, LTE, 3G, 2G, and/or the like; Bluetooth network; and/or other wireless network access point) that has a dynamic or non-static location. For example, the mobile access point may be a tethered access point assigned to a mobile device, or the mobile access point may be onboard a bus (e.g., a public transportation bus, charter bus, intracity bus, intercity bus, and/or the like), a train and/or subway car, a passenger car, a truck, airplane, boat, and/or the like. In various embodiments, the mobile access point identification process is configured to identify mobile access points and provide and/or record (e.g., store) information regarding identified mobile access points. For example, the information regarding identified mobile access points may be used to prevent the use of mobile access point in determining position estimates, providing information regarding network access points that are available via various forms of transportation, and/or the like. In an example embodiment, the mobile access point identification process is configured to, responsive to determining that one or more observations of an access point by the mobile device satisfy one or more observation criteria and the context categorization for the mobile device comprises a vehicle motion state indicating a vehicle that the mobile device is onboard is moving, determine that the access point is a mobile access point. In an example embodiment, responsive to determining that an access point is a mobile access point, the mobile access point identification process is configured to cause an access point registry (e.g., a radio map, list of access points, database of access point information, and/or the like) to be updated to indicate that the access point is a mobile access point. In an example embodiment, the capturing of the audio sample used to determine the context categorization for the mobile device is triggered responsive to determining that one or more observations of an access point by the mobile device satisfy the one or more observation criteria. In various embodiments, the observation criteria comprise a combination of a signal strength threshold and a threshold amount of time.

In various embodiments, the crowd-sourcing or positioning process is configured to determine a position estimate for the mobile device. In various embodiments, one or more parameters used in determining the position estimate for the mobile device are determined based at least in part on the context categorization for the mobile device.

In various embodiments, the crowd-sourcing or positioning process is configured to determine whether to cause the mobile device to capture and/or provide crowd-sourced information based at least in part on the context categorization for the mobile device. For example, crowd-sourced information may be desired that corresponds to particular context categorizations. For example, it may be desired to capture radio data regarding the environment within one or more buildings. Thus, it may be desired to capture radio data for mobile devices associated with a context categorization comprising a vehicle type of no vehicle/pedestrian. For example, in an example embodiment, the crowd-sourcing or positioning process is configured to generate an indoor positioning map based at least in part on crowd-sourced information captured by one or more sensors of the mobile device when the mobile device is associated with a context configuration comprising a vehicle type of no vehicle/pedestrian. In another example, it may be desired to capture passenger movement patterns on a bus, train, airplane, and/or the like and therefore IMU data may be captured for mobile devices associated with a context categorization comprising a vehicle type corresponding to the desired vehicle type passenger movement patterns. For example, in an example embodiment, the crowd-sourcing or positioning process is configured to determine a user movement pattern for at least one type of vehicle based on crowd-sourced information captured by one or more sensors of the mobile device when the mobile device is associated with a context configuration comprising a vehicle type matching and/or corresponding to the at least one type of vehicle.

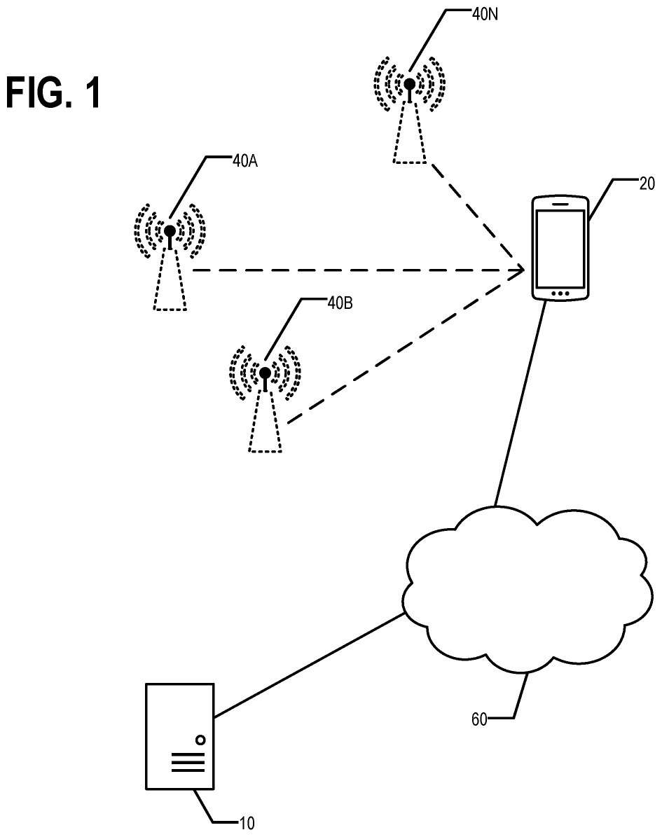

FIG. 1 provides an illustration of an example system that can be used in conjunction with various embodiments of the present invention. As shown in FIG. 1, the system includes one or more network devices 10, one or more mobile devices 20, one or more networks 60, and/or the like. In various embodiments, the system further includes one or more access points 40 (e.g., 40A, 40B, 40N). In various embodiments, a mobile device 20 is a smart phone, tablet, laptop, personal digital assistant (PDA), mobile computing device, and/or the like. In an example embodiment, the network device 10 is a server, group of servers, distributed computing system, part of a cloud-based computing system, and/or other computing system. In various embodiments, the access points 40 are wireless network access points and/or gateways such as Wi-Fi network access points, cellular network access points, Bluetooth access points, and/or the like. For example, the network device 10 may be in communication with one or more mobile devices 20, via one or more wired or wireless networks 60.

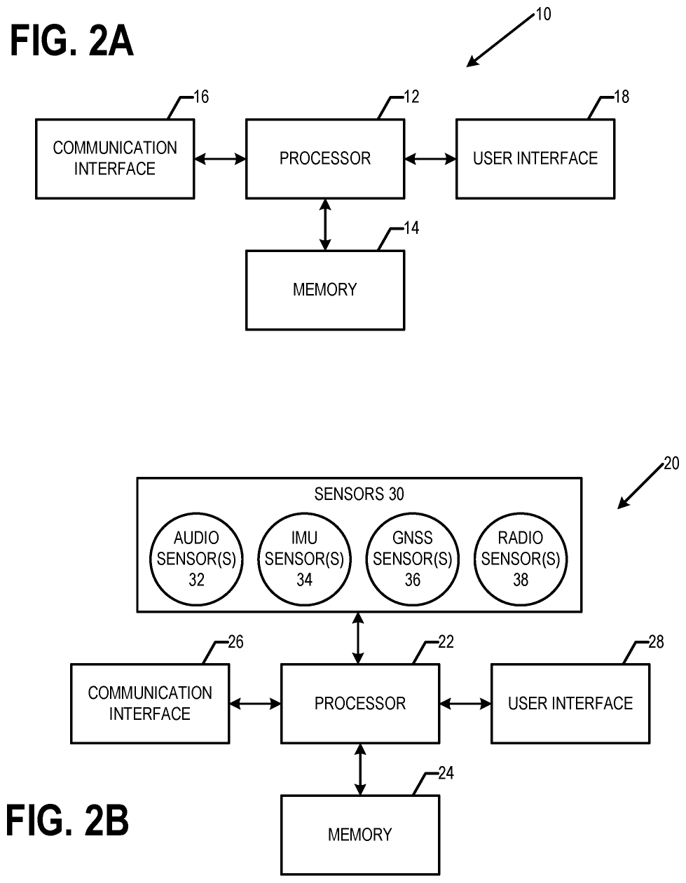

In an example embodiment, a network device 10 may comprise components similar to those shown in the example network device 10 diagrammed in FIG. 2A. In an example embodiment, the network device 10 is configured to obtain a plurality of audio samples that are associated with labels indicating respective context categorizations, use the plurality of audio samples to train a classification engine to determine and/or estimate a context categorization based on an audio sample, provide the classification engine (e.g., parameters and/or architecture information defining the classification engine), obtain an audio sample captured by a mobile device 20, use the classification engine to determine and/or estimate a context configuration based on the obtained audio sample, provide the context configuration to a crowd-sourcing and/or positioning process operating on the network device 10 or the mobile device 20, and/or the like.

For example, as shown in FIG. 2A, the network device 10 may comprise a processor 12, memory 14, a user interface 18, a communications interface 16, and/or other components configured to perform various operations, procedures, functions, or the like described herein. In various embodiments, the network device 10 stores a geographical database and/or positioning map, such as a radio environment and/or cellular network access point positioning map (e.g., an access point registry), computer program code and/or instructions for one or more crowd-sourcing or positioning functions, computer program code and/or instructions for training and/or operating a classification engine, and/or the like (e.g., in memory 14), for example. In at least some example embodiments, the memory 14 is non-transitory.

In an example embodiment, the mobile device 20 is configured to determine that a trigger condition has been satisfied, capture an audio sample (e.g., responsive to determining that the trigger condition has been satisfied), provide the audio sample (e.g., transmit the audio sample or provide the audio sample to a categorization engine operating on the mobile device), receive a context categorization determined and/or estimated based on the audio sample and/or a result of crowd-sourcing or positioning process determined based on the context categorization, perform one or more functions based on the context categorization or the result of the crowd-sourcing or positioning process, and/or the like.

In an example embodiment, the mobile device 20 is a mobile computing device such as a smartphone, tablet, laptop, PDA, an Internet of things (IoT) device, and/or the like. In an example embodiment, as shown in FIG. 2B, the computing device 20 may comprise a processor 22, memory 24, a communications interface 26, a user interface 28, one or more sensors 30 and/or other components configured to perform various operations, procedures, functions or the like described herein. In various embodiments, the computing device 20 stores at least a portion of one or more digital maps (e.g., geographic databases, positioning maps, and/or the like) and/or computer executable instructions for determining a trigger condition is satisfied, capturing and/or providing an audio sample, capturing and/or providing IMU data, capturing and/or providing radio data, and/or the like in memory 24. In at least some example embodiments, the memory 24 is non-transitory.

In various embodiments, the sensors 30 comprise one or more audio sensors 32, one or more IMU sensors 34, one or more GNSS sensors 36, one or more radio sensors 38, and/or other sensors. In an example embodiment, the one or more audio sensors 32 comprise one or more microphones and/or other audio sensors. In an example embodiment, the one or more IU sensors 34 comprise one or more accelerometers, gyroscopes, magnetometers, and/or the like. In various embodiments, the one or more GNSS sensor(s) 36 are configured to communicate with one or more GNSS satellites and determine GNSS-based location estimates and/or other information based on the communication with the GNSS satellites. In various embodiments, the one or more radio sensors 38 comprise one or more radio interfaces configured to observe and/or receive signals generated and/or transmitted by one or more access points and/or other computing entities (e.g., access points 40). For example, the one or more interfaces may be configured (possibly in coordination with processor 22) to determine a locally unique identifier, globally unique identifier, and/or operational parameters of a network access point 40 observed by the radio sensor(s) 38. As used herein, a radio sensor 38 observes an access point 40 by receiving, capturing, measuring and/or observing a signal generated and/or transmitted by the access point 40. In an example embodiment, the interface of a radio sensor 38 may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor 38 may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) 38 may be configured to observe radio, millimeter, microwave, and/or infrared wavelength signals. In an example embodiment, the interface of radio sensor 38 may be coupled to and/or part of a communications interface 26. In various embodiments, the sensors 30 may further comprise one or more image sensors configured to capture visual samples, such as digital camera(s), 3D cameras, 360° cameras, and/or image sensors. In various embodiments, the one or more sensors 30 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a mobile device 20 may be in communication with a network device 10 via the network 60. For example, a mobile device 20 may communicate with the network device 10 via a network, such as the Cloud. For example, the Cloud may be a computer network that provides shared computer processing resources and data to computers and other devices connected thereto. For example, the mobile device 20 capture an audio sample and provide the audio sample such that the network device 10 receives the audio sample via the network 60. For example, the network device 10 may be configured to provide a classification engine and/or receive audio samples via the network 60.

Certain example embodiments of the network device 10 and mobile device 20 are described in more detail below with respect to FIGS. 2A and 2B.

### II. Example Operation(s)

In various embodiments, a classification engine is trained (e.g., by a network device 10) to determine or estimate a context categorization corresponding to an audio sample. For example, the classification engine is trained (e.g., by a network device 10) such that the classification engine can determine and/or estimate a context categorization for a mobile device 20 based on an audio sample captured by an audio sensor of the mobile device. Training of the classification engine comprises obtaining a plurality of audio samples that are associated with labels indicating a respective context categorization corresponding to the context under which the respective audio sample was captured. A (supervised) machine learning technique may be used to determine, estimate, optimize, and/or the like one or more parameters of the defined architecture for the classification engine.

The network device 10 or mobile device 20 may then use the classification engine to determine and/or estimate a context categorization for the mobile device 20 based on an audio sample capture by the mobile device 20. The context categorization is provided as input to a crowd-sourcing or positioning process. In various embodiments, the crowd-sourcing or positioning process is configured to determine an access point observation-based position estimate for a mobile device and one or more parameters used to determine the access point observation-based position estimate are selected and/or determined based on the context categorization for the mobile device 20. In various embodiments, the crowd-sourcing or positioning process is configured to identify mobile access points and update an access point registry to indicate the identification of a mobile access point. In an example embodiment, the crowd-sourcing or positioning process is configured to determine whether the mobile device 20 is eligible to provide crowd-sourcing information and/or if crowd-sourcing information provided by the mobile device 20 is eligible to be used in a crowd-sourced information/data project. In various embodiments, the crowd-sourced information/data project may be generation and/or updating of a positioning map (e.g., a radio map), identification of mobile access points, determination of passenger movement patterns for a particular vehicle type, and/or the like.

### A. Exemplary Preparation of a Classification Engine

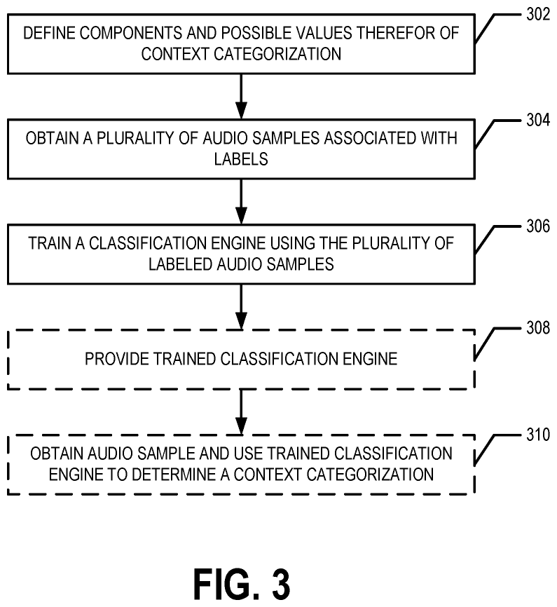

FIG. 3 illustrates a flowchart illustrating processes, procedures, steps, operations, and/or the like for preparing a classification engine for use. In various embodiments, the processes, procedures, steps, operations, and/or the like shown in FIG. 3 are performed by a network device 10.

Starting at block 302, the components of the context categorization and the possible values for the components of the context categorization are defined. For example, the network device 10 may define the components of the context categorization and the possible values for the components of the context categorization. For example, the network device 10 may comprise means, such as processor 12, memory 14, communications interface 16, user interface 18, and/or the like, for defining the components of the context categorization and the possible values for the components of the context categorization. In various embodiments, the context categorization is defined to comprise at least two components. The at least two components comprise at least one motion state and a vehicle type. In an example embodiment, the at least one motion state comprises a user motion state describing user motion of a user associated with the mobile device and/or a vehicle motion state indicating a vehicle motion of a vehicle associated with the mobile device.

For example, in an example embodiment, the possible values for the type of vehicle component include no vehicle/pedestrian, bicycle, motorbike, golf cart, passenger car, truck, bus, train, subway, airplane, boat, and/or the like. In an example embodiment, the possible values for the user motion state describing user motion of a user associated with the mobile device include still, walking, or running. In an example embodiment, the possible values for the vehicle motion state include still, moving at a low speed that is less than a low speed threshold, moving at a moderate speed that is in a range between the low speed threshold and a high speed threshold, and moving at a high speed, that is greater than the high speed threshold. In an example embodiment, the low speed and high speed thresholds are vehicle type specific. For example, the low speed threshold may be 20 miles per hour, 25 miles per hour, 30 miles per hour, 30 kilometers per hour, 40 kilometers per hour, 50 kilometers per hour, and/or the like, in various embodiments. For example, the high speed threshold may be 50 miles per hour, 55 miles per hour, 60 miles per hour, 80 kilometers per hour, 90 kilometers per hour, 100 kilometers per hour, and/or the like, in various embodiments. In an example embodiment, the above-referenced high speed and low speed thresholds correspond to vehicle types corresponding to motorized vehicles and the low and/or high speed threshold for vehicle types corresponding to non-motorized vehicles are lower. In an example embodiment, the high speed and low speed thresholds are used for each vehicle type (possibly other than no vehicle/pedestrian). In an example embodiment, the possible values for the vehicle motion state include still, moving at a low speed that is less than a speed threshold, and moving at a high speed that is greater than the speed threshold. In an example embodiment, the speed threshold is 30 miles per hour, 35 miles per hour, 40 miles per hour, 50 kilometers per hour, 60 kilometers per hour, 70 kilometers per hour, and/or the like. In an example embodiment, the possible values for the vehicle motion state including still and moving. In various embodiments, a variety of vehicle motion state values may be defined as appropriate for the application and the requirements of the associated crowd-sourcing or positioning processes.

At block 304, a plurality of audio samples are obtained. In various embodiments, the audio samples are associated with labels that indicate respective context categorizations that correspond to the context under which the respective audio sample was captured. In an example embodiment, the plurality of audio samples comprises at least one audio sample (preferably more than one audio sample) corresponding to various possible context categorizations. In an example embodiment, the plurality of audio samples comprises at least one audio sample corresponding to each possible context categorization. In various embodiments, the possible context categorizations consist of the combinations of values of components of the context categorization that are physically and/or logically possible. For example, for context categorizations comprising user motion state, vehicle motion state, and vehicle type components, some possible context categorizations include those shown in Table 1. However, the context categorizations shown in Table 2 may not be possible.

TABLE 1

| User Motion State | Vehicle Motion State | Vehicle Type |
|---|---|---|
| Still | — | No Vehicle/Pedestrian |
| Running | — | No Vehicle/Pedestrian |
| Still | Still | Passenger Car |
| Still | Moving - medium speed | Train |
| Walking | Moving - low speed | Train |

TABLE 2

| User Motion State | Vehicle Motion State | Vehicle Type |
|---|---|---|
| Still | Moving - high speed | No Vehicle/Pedestrian |
| Walking | Moving - low speed | Passenger Car |

In various embodiments, the audio samples associated with a label indicating a particular context categorization may be captured under a variety of circumstances. For example, for the particular context categorization corresponding to a user motion state of still, vehicle motion state of moving, and vehicle type of passenger car, audio samples may be captured while the passenger car is driving down various types of roads (e.g., highways, arterial roads, collector roads, local roads, urban roads, suburban roads, rural roads, dirt roads, paved roads, and/or the like), with the audio sample recording device located at various positions within the passenger car, when the passenger car is moving at different speeds, and/or the like for various makes and models of passenger cars. Similarly, a plurality of audio samples captured under various possible context categorizations are captured under a wide variety of circumstances, environmental and/or weather conditions, geographical locations, makes and models of the vehicle type, different positions within the vehicle, and/or the like.

In various embodiments, at least one audio sample of the plurality of audio samples is obtained via a crowd-sourcing technique. In an example embodiment, at least one audio sample of the plurality of audio samples is obtained via a dedicated survey. For example, a user device (e.g., a mobile device 20) may capture and provide audio samples such that the network device 10 obtains the audio samples. In various embodiments, a user of the user device that captured the audio sample will provide user input (e.g., via a user interface 28) indicting the context categorization corresponding to the captured audio sample. The audio sample is then labeled and/or associated with a label according to the user provided and/or indicated context categorization. In various embodiments, the user device may capture GNSS data (e.g., position, speed, etc.) and/or IMU data (e.g., indication of detection of user steps) and an audio sample captured by the user device is labeled and/or associated with a label based on an analysis and/or context categorization determination based on the GNSS data and/or the IMU data.

For example, the network device 10 obtains a plurality of audio samples that are each labeled with an indication of a respective context categorization corresponding to the context under which the respective audio sample was captured. For example, the network device 10 comprises means, such as processor 12, memory 14, communications interface 16, and/or the like for obtaining a plurality of audio samples that are each labeled with an indication of a respective context categorization corresponding to the context under which the respective audio sample was captured. In various embodiments, the plurality of audio samples are received via a communications interface 16 of the network device 10. In various embodiments, the plurality of audio samples are accessed from memory 14. In an example embodiment, the audio samples are associated with IMU data (e.g., acceleration, rotation, magnetic field changes, and/or other IMU data) captured while the audio sample was being captured.

At block 306, the classification engine is trained based at least in part on the plurality of audio samples and the associated labels. For example, various supervised machine learning strategies are used to train the classification engine based at least in part on the plurality of audio samples and the associated labels, in various embodiments. For example, the architecture of the classification engine may be selected and/or defined. For example, the classification engine is one of is one of a k-nearest neighbor classifier, a linear classifier, a Bayesian classifier, a decision tree, or a neural network, in various embodiments. A machine learning process is then used to train the classification engine. In various embodiments, training the classification engine comprises determining, optimizing, and/or otherwise assigning values to the parameters of the selected and/or defined architecture based on analysis, processing, and/or the like of the plurality of audio samples and the associated labels. For example, a stochastic gradient descent method is used to minimize and/or reduce a defined loss function that compares a determined context categorization for an audio sample of the plurality of audio samples to the context categorization indicted by the label associated with the audio sample, in an example embodiment. For example, the network device 10 may train or cause the training of the classification engine based at least in part on the plurality of audio samples and the associated labels. For example, the network device 10 may comprise means, such as processor 12, memory 14, communications interface 16, and/or the like, for training or causing the training of the classification engine based at least in part on the plurality of audio samples and the associated labels. In an example embodiment, the training of the classification engine also uses IMU data associated with at least some of the audio samples of the plurality of audio samples in the training process and/or the determination and/or estimation of the context categorization for an audio sample.

At block 308, the trained classification engine is optionally provided. For example, the network device 10 may provide (e.g., transmit) the trained classification engine such that another computing entity (e.g., a mobile device 20) receives the trained classification engine and may use the classification engine to determine and/or estimate a context categorization corresponding to an audio sample. For example, the network device 10 may comprise means, such as processor 12, memory 14, communications interface 16, and/or the like, for providing the trained classification engine. In various embodiments, providing the trained classification engine comprises providing information indicating the architecture of the classification engine and providing the values of the parameters of the classification engine.

At block 310, the network device 10 may obtain at least a first audio sample and use the trained classification engine to determine and/or estimate a context categorization for the first audio sample. For example, the network device 10 may provide the first audio sample as input to the trained classification engine (e.g., provide the first audio sample to the input layer and/or input node of the trained classification engine) and receive, obtain, and/or access a determined or estimated context categorization for the first audio sample (e.g., at and/or from the output layer and/or output node(s) of the trained classification engine). For example, the network device 10 may comprise means, such as processor 12, memory 14, communications interface 16, and/or the like, for determining and/or estimating a context classification for a first audio sample using the trained classification engine.

B. Exemplary Determination and/or Estimation of a Context Categorization

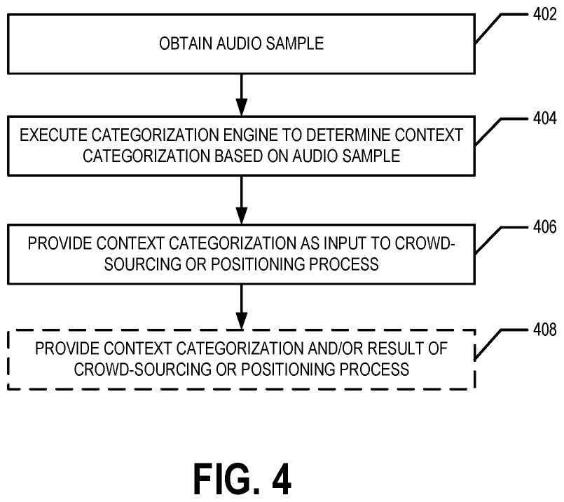

FIG. 4 provides a flowchart of processes, procedures, operations, and/or the like performed by a network device 10 and/or mobile device 20 to determine and/or estimate a context categorization for a mobile device 20 based on an audio sample captured by the mobile device 20. For example, a program, application, operating system, and/or the like operating and/or executing on the mobile device 20 may determine and/or identify that a trigger condition has been satisfied, and, responsive thereto, capture an audio sample. The mobile device 20 may then use a locally stored classification engine to determine and/or estimate a context categorization for the mobile device 20 based on the audio sample or the mobile device 20 may provide (e.g., transmit) the audio sample such that a network device 10 determines and/or estimates a context categorization for the mobile device 20 based on the audio sample.

Starting at block 402, an audio sample is obtained. For example, the network device 10 and/or the mobile device 20 may obtain an audio sample. For example, the network device 10 and/or mobile device 20 may comprise means, such as processor 12, 22, memory 14, 24, communications interface 16, 26, audio sensor 32, and/or the like, for obtaining an audio sample. For example, the mobile device 20 may cause one or more audio sensors 32 to capture an audio sample, such that the mobile device 20 obtains the audio sample. For example, the network device 10 may receive (e.g., via communications interface 16) an audio sample that was captured by one or more audio sensors 32 of a mobile device 20 and provided (e.g., transmitted) by the mobile device (e.g., via communications interface 26).

At block 404, the classification engine is executed to cause a context categorization for the mobile device 20 to be determined and/or estimated based at least in part on the audio sample. For example, the network device 10 and/or the mobile device 20 may execute the classification engine to cause a context categorization for the mobile device 20 to be determined and/or estimated based at least in part on the audio sample. For example, the network device 10 and/or the mobile device 20 comprise means, such as processor 12, 22, memory 14, 24, and/or the like, for executing the classification engine to cause a context categorization for the mobile device 20 to be determined and/or estimated based at least in part on the audio sample. For example, the audio sample is provided to an input layer and/or node of the classification engine. The architecture and parameters of the classification engine control the transformation of the audio sample received at the input layer and/or input node into a determined and/or estimated context categorization at the output layer and/or output node(s) of the classification engine.

At block 406, the determined and/or estimated context categorization for the mobile device 20 is provided as input to a crowd-sourcing and/or positioning process. For example, the network device 10 and/or mobile device 20 may provide the determined and/or estimated context categorization for the mobile device 20 as input to a crowd-sourcing and/or positioning process. For example, the network device 10 and/or the mobile device 20 may comprise means, such as processor 12, 22, memory 14, 24, communications interface 16, 26, and/or the like, for providing the determined and/or estimated context categorization for the mobile device 20 as input to a crowd-sourcing and/or positioning process.

In various embodiments, the crowd-sourcing and/or positioning process is operating on the mobile device 20, on the network device 10, and/or on a Cloud-based computing asset. In an example embodiment, the determined and/or estimated context categorization is provided to the crowd-sourcing and/or positioning process as an API call or as an API response (e.g., when the capturing of the audio sample and/or the determination and/or estimation of the context categorization was trigger by an API call generated by the crowd-sourcing and/or positioning process).

In various embodiments, the crowd-sourcing or positioning process is a mobile access point identification process. In various embodiments, a mobile access point is a network access point (e.g., Wi-Fi network, cellular network, Bluetooth network, and/or other wireless network access point) that has a dynamic or non-static location. For example, the mobile access point may be onboard a bus (e.g., a public transportation bus, charter bus, intracity bus, intercity bus, and/or the like), a train and/or subway car, a passenger car, a truck, airplane, boat, and/or the like. In various embodiments, the mobile access point identification process is configured to identify mobile access points and provide and/or record (e.g., store) information regarding identified mobile access points. For example, the information regarding identified mobile access points may be used to prevent the use of mobile access point in determining position estimates, providing information regarding network access points that are available via various forms of transportation, and/or the like. In an example embodiment, the mobile access point identification process is configured to, responsive to determining that one or more observations of an access point by the mobile device satisfy one or more observation criteria and the context categorization for the mobile device comprises a vehicle motion state indicating a vehicle that the mobile device is onboard is moving, determine that the access point is a mobile access point. In an example embodiment, responsive to determining that an access point is a mobile access point, the mobile access point identification process is configured to cause an access point registry (e.g., a radio map, list of access points, database of access point information, and/or the like) to be updated to indicate that the access point is a mobile access point. In an example embodiment, the capturing of the audio sample that was used to determine the context categorization for the mobile device is triggered responsive to determining that one or more observations of an access point by the mobile device satisfy the one or more observation criteria.

In various embodiments, the crowd-sourcing or positioning process is configured to determine a position estimate for the mobile device 20. In various embodiments, one or more parameters used in determining the position estimate for the mobile device 20 are determined based at least in part on the context categorization for the mobile device. For example, one or more parameters, filters, and/or the like used to determine a radio-based position estimate for the mobile device 20 (e.g., a position estimate determined based on radio frequency network access points, nodes, beacons, and/or the like observed by the mobile device) are determined, selected, and/or the like based on the context categorization for the mobile device 20.

In various embodiments, the crowd-sourcing or positioning process is configured to determine whether to cause the mobile device 20 to capture and/or provide crowd-sourced information based at least in part on the context categorization for the mobile device. For example, crowd-sourced information may be desired that corresponds to particular context categorizations. For example, it may be desired to capture radio data regarding the environment within one or more buildings. Thus, it may be desired to capture radio data by mobile devices 20 associated with a context categorization comprising a vehicle type of no vehicle/pedestrian. For example, in an example embodiment, the crowd-sourcing or positioning process is configured to generate an indoor positioning map based at least in part on crowd-sourced information captured by one or more sensors (e.g., IMU sensors 34, GNSS sensors 36, radio sensors 38, and/or the like) of the mobile device 20 when the mobile device 20 is associated with a context configuration comprising a vehicle type of no vehicle/pedestrian. In another example, it may be desired to capture passenger movement patterns on a bus, train, airplane, and/or the like and therefore IMU data may be captured (e.g., using IMU sensors 34) by mobile devices 20 associated with a context categorization comprising a vehicle type corresponding to the desired vehicle type passenger movement patterns. For example, in an example embodiment, the crowd-sourcing or positioning process is configured to determine a user movement pattern for at least one type of vehicle based on crowd-sourced information captured by one or more sensors (e.g., IMU sensors 34, GNSS sensors 36, radio sensors 38) of the mobile device 20 when the mobile device 20 is associated with a context configuration comprising a vehicle type matching and/or corresponding to the at least one type of vehicle.

At block 408, the context categorization and/or a result of the crowd-sourcing or positioning process based on the context categorization is optionally provided. For example, when the crowd-sourcing or positioning process is configured to determine a position estimate for the mobile device 20 based at least in part on the context configuration, the result of the crowd-sourcing or positioning process is a position estimate for the mobile device 20. For example, when the crowd-sourcing or positioning process is configured to determine whether the mobile device 20 should capture data (e.g., via one or more sensors 30) for use in performing a function based on crowd-sourced information/data (e.g., identification of mobile access points, mapping of locations of network access points, determination of a passenger movement pattern for at least one type of vehicle, and/or the like), the result of crowd-sourcing or positioning process is an indication of whether or not the mobile device 20 should capture and provide crowd-sourced information/data, what types of data the mobile device 20 should capture and provide as crowd-sourced information/data, and/or the like.

For example, the network device 10 and/or the mobile device 20 may provide the context categorization and/or a result of the crowd-sourcing or positioning process based on the context categorization. For example, the network device 10 and/or the mobile device 20 may comprise means, such as processor 12, 22, memory 14, 24, communications interface 16, 26, and/or the like, for providing the context categorization and/or a result of the crowd-sourcing or positioning process based on the context categorization. For example, a network device 10 may operate and/or execute the crowd-sourcing or positioning process or be in communication (e.g., via network 60) with a Cloud-based computing asset operating and/or executing the crowd-sourcing or positioning process, and the network device 10 may provide the context categorization and/or a result of the crowd-sourcing or positioning process based on the context categorization such that the mobile device 20 receives the context categorization and/or the result. For example, the mobile device 20 may provide the context categorization and/or the result of the crowd-sourcing or positioning process based on the context categorization to an application and/or program operating and/or executing on the mobile device 20 (e.g., by processor 22) that is configured to capture and provide the crowd-sourced information/data for use by a crowd-sourcing function and/or that is configured to receive a position estimate for the mobile device 20 as an input.

### C. Exemplary Operation of a Mobile Device

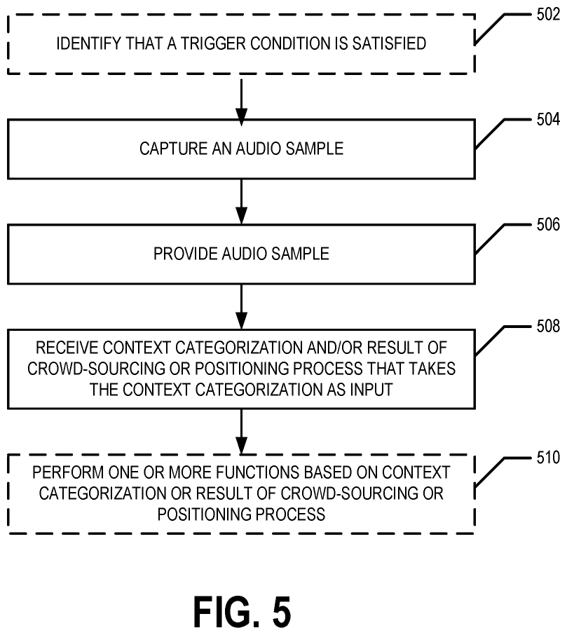

FIG. 5 illustrates various processes, procedures, operations, and/or the like of a mobile device 20 to determine or estimate (or have determined or estimated by a network device 10) a context categorization for the mobile device and to use the determined or estimated context categorization, or a result of a crowd-sourcing or positioning process determined based on the determined or estimated context categorization, to perform one or more functions, such as crowd-sourcing, positioning, and/or navigation-related functions.

Starting at block 502, in an example embodiment, the mobile device 20 identifies and/or determines that a trigger condition has been satisfied. For example, the mobile device 20 comprises means, such as processor 22, memory 24, communications interface 26, user interface 28, sensors 30, and/or the like, for determining that a trigger condition has been satisfied.

For example, the trigger condition may be satisfied when one or more sensor measurements captured by sensors 30 of the mobile device 20 indicate that GNSS-based measurements are not available. In another example, the trigger condition may be satisfied when the context categorization cannot be determined or cannot be determined to a desired confidence level based on data captured by the IMU sensors 34 of the mobile device 20. In another example, the trigger condition is satisfied when one or more sensor measurements captured by sensors 30 of the mobile device 20 indicate that one or more crowd-sourcing criteria are satisfied. For example, the crowd-sourcing criteria may correspond to a location, available sensors 30 of the mobile device 20, and/or other considerations and/or criteria defined for desired crowd-sourced information/data that are used to determine whether the mobile device 20 is qualified to provide crowd-sourced information/data for use by one or more crowd-sourcing functions. In another example, the trigger condition is satisfied when one or more sensor measurements captured by sensors 30 of the mobile device 20 indicate that a particular radio device or network access point 40 is detected and/or observe to have at least a threshold signal strength for at least a threshold amount of time (e.g., one minute, three minutes, five minutes, ten minutes, and/or the like). In still another example, the trigger condition may be satisfied when it is determined that an indoor and/or radio observation-based positioning estimate for the mobile device 20 is to be performed and/or determined.

At block 504, possibly in response to determining that a trigger condition has been satisfied, an audio sample is captured. For example, one or more audio sensors 32 of the mobile device are caused to capture an audio sample. For example, the mobile device 20 captures an audio sample. For example, the mobile device 20 comprises means, such as processor 22, memory 24, communications interface 26, audio sensor 32, and/or the like, for capturing an audio sample. In various embodiments, the audio sample encodes one or more noises, sounds, and/or the like in the environment surrounding the mobile device 20. In various embodiments, the audio sample is half a second to two seconds long, two to five seconds long, five to fifteen seconds long, fifteen to thirty seconds long, or longer than thirty seconds. In various embodiments, the length of the audio sample is a fixed or preset temporal length. In an example embodiment, the length of the audio sample is determined based on the clarity and/or volume of sound captured and/or detected by the audio sensors 32. For example, when a mobile device 20 is being held in a user's hand, dash-mounted mobile device holder, and/or the like, a short audio sample may suffice compare to when the mobile device 20 is in a user's pocket or bag and the sounds captured by the audio sensors 32 are more muffled.

At block 506, the mobile device 20 provides the audio sample. In an example embodiment, the mobile device 20 transmits the audio sample such that the network device 10 receives the audio sample and uses a classification engine to determine or estimate a context categorization for the mobile device 20 based on the audio sample. In an example embodiment, the mobile device 20 provides the audio sample as input to a locally stored and/or executed classification engine. In an example embodiment, the locally stored and/or executed classification engine is configured to provide the determined and/or estimated context categorization to a crowd-sourcing or positioning process (e.g., operating on the mobile device 20, network device 10, and/or another cloud-based computing asset). For example, the mobile device 20 comprises means, such as processor 22, memory 24, communications interface 26, and/or the like for providing the audio sample.

At block 508, the mobile device 20 receives the context categorization and/or a result of a crowd-sourcing or positioning process that takes the context categorization as input. For example, the mobile device 20 comprises means, such as processor 22, memory 24, communications interface 26, and/or the like for receiving the context categorization and/or the result of the crowd-sourcing or positioning process that takes the context categorization as input. For example, the result may be a position estimate for the mobile device 20, an indication of whether/what crowd-sourced information/data the mobile device 20 should capture and provide, and/or the like.

At block 510, the mobile device 20 performs one or more functions based at least in part on the context categorization and/or a result of a crowd-sourcing or positioning process that takes the context categorization as input. For example, the mobile device 20 comprises means, such as processor 22, memory 24, communications interface 26, user interface 28, sensors 30, and/or the like, for performing one or more functions based at least in part on the context categorization and/or a result of a crowd-sourcing or positioning process that takes the context categorization as input.

For example, the mobile device 20 may perform one or more positioning and/or navigation-related functions based at least in part on the context categorization and/or a result (e.g., a position estimate) of a crowd-sourcing or positioning process that takes the context categorization as input. Some non-limiting examples of positioning-related and/or navigation-related functions include localization, provision of location dependent and/or triggered information, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, and/or the like.

In another example, the mobile device 20 may launch and/or activate one or more applications and/or programs on the mobile device 20 (e.g., execute executable program code and/or instructions associated therewith with the processor 22) based on the context categorization and/or a result of a crowd-sourcing or positioning process that takes the context categorization as input. For example, the mobile device 20 may launch and/or activate a fitness application particular to walking, running, biking, and/or the like based on the context categorization and/or a result of a crowd-sourcing or positioning process that takes the context categorization as input. For example, the mobile device 20 may launch and/or activate an application and/or program configured to capture and/or provide crowd-sourced information/data based on the context categorization and/or a result (e.g., an indication of whether/what crowd-sourced information/data the mobile device 20 should capture and provide) of a crowd-sourcing or positioning process that takes the context categorization as input. For example, the application and/or program may be configured to capture and/or provide crowd-sourced information/data for identifying mobile access points, mapping the locations of network access points, determining passenger movement patterns on a particular type of vehicle, and/or the like.

### III. Technical Advantages

Various embodiments provide technical solutions to the technical problems of determining and/or estimating a context categorization for a mobile device 20 in scenarios where GNSS- and/or IMU-based context categorizations cannot be determined or may be unreliable. In particular, in various scenarios a mobile device may be configured to perform various functions based on a context categorization (e.g., at least one motion state, such as a user motion state and/or vehicle motion state, and a vehicle type) or based on a result (e.g., a position estimate, an indication of whether/what crowd-sourced information/data the mobile device 20 should capture and provide, and/or the like) of a crowd-sourcing or positioning process that uses the context categorization as input. However, such functionality of the mobile device requires that a context categorization be able to be determined and/or estimated reliably under a wide variety of conditions and circumstances (e.g., even when GNSS- and/or IMU-based context categorizations cannot be determined or are not reliable). Thus, a technical problem regarding how to reliably determine and/or estimate a context categorization for a mobile device under a wide variety of conditions and circumstances exist.

Various embodiments described herein provide a technical solution to these technical problems. In particular, an audio sample that captures sounds and/or noises in the environment about the mobile device are analyzed, processed, and/or transformed by a classification engine into a determined and/or estimated context categorization for the mobile device. The classification engine is executed locally on the mobile device in various embodiments to enable determination and/or estimation of a context categorization without latency and without use of network bandwidth. The classification is executed by a remote server and/or cloud-based computing asset in various embodiments to reduce the processing load performed by the mobile device. Notably, various embodiments enable the determination and/or estimation of the context categorization under circumstances and/or conditions when GNSS- and/or IMU-based context categorizations cannot be determined or are not reliable.

Various embodiments provide additional technical advantages. For example, by using the context categorization to determine and/or select one or more parameters and/or filters used to determine a radio-based (e.g., observed network access point-based) positioning estimate, the accuracy of the positioning estimate is improved. In another example, by using the context categorization to determine whether a mobile device that satisfies at least one crowd-sourcing criteria is qualified to provide crowd-sourced information/data for use in a crowd-sourced function reduces the amount of bandwidth used by mobile devices 20 sending unusable crowd-sourced information/data and reduces the amount of filtering needing to be performed by the network device 10 to remove unusable and/or inappropriate crowd-sourced information/data from a crowd-sourced information/data set. In still another example, using the context categorization, mobile access points may be identified and an access point registry may be updated to indicate that the mobile access point has a dynamic and/or non-static position, track a route the mobile access point traverses, and/or the like. Thus, various embodiments provide a variety of technical improvements to the improvement of the mobile device, bandwidth and processing power efficient crowd-sourced information/data collection, radio map generation, and/or the like.

### IV. Example Apparatus

The network device 10 and/or mobile device 20 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, and/or other device that can observe the radio environment (e.g., receive radio frequency signals from network access points) in the vicinity of the computing device and/or that can store at least a portion of a positioning map. Additionally or alternatively, the network device 10 and/or mobile device 20 may be embodied in other types of computing devices, such as a server, a personal computer, a computer workstation, a laptop computer, a plurality of networked computing devices or the like, that are configured to capture and provide audio samples, train a classification engine, execute a classification engine taking an audio sample as input, execute a crowd-sourcing or positioning process, and/or the like. In an example embodiment, a mobile device 20 is a smartphone, tablet, laptop, PDA, and/or other mobile computing device and a network device 10 is a server that may be part of a Cloud-based computing asset and/or processing system.

In some embodiments, the processor 12, 22 (and/or co-processors or any other processing circuitry assisting or otherwise associated with the processor) may be in communication with the memory device 14, 24 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10 and/or mobile device 20 may be embodied by a computing entity and/or device. However, in some embodiments, the network device 10 and/or mobile device 20 may be embodied as a chip or chip set. In other words, the network device 10 and/or mobile device 20 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22 may be embodied in a number of different ways. For example, the processor 12, 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22 may include one or more processing cores configured to perform independently. A multi-core processor may enable multiprocessing within a single physical package. Additionally or alternatively, the processor 12, 22 may include one or more processors configured in tandem via the bus to enable independent execution of instructions, pipelining and/or multithreading.

In an example embodiment, the processor 12, 22 may be configured to execute instructions stored in the memory device 14, 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10 and/or mobile device 20 may include a user interface 18, 28 that may, in turn, be in communication with the processor 12, 22 to provide output to the user, such as one or more navigable routes to a destination location and/or from an origin location, display of location dependent and/or triggered information, and/or the like, and, in some embodiments, to receive an indication of a user input. As such, the user interface 18, 28 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22 (e.g., memory device 14, 24 and/or the like).

The network device 10 and/or mobile device 20 may optionally include a communication interface 16, 26. The communication interface 16, 26 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10 and/or mobile device 20 may comprise a component (e.g., memory 14, 24, and/or another component) that stores a digital map (e.g., in the form of a geographic database) comprising a first plurality of data records, each of the first plurality of data records representing a corresponding traversable map element (TME). At least some of said first plurality of data records map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a positioning map comprising an access point registry and/or instances of network access point information corresponding to various network access points. For example, a geographic database may include road segment, segment, link, lane segment, or TME data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more data records of the geographic database. For example, the network device 10 may modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

### V. Apparatus, Methods, and Computer Program Products

As described above, FIGS. 3, 4, and 5 illustrate flowcharts of a network device 10 and/or mobile device 20, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24 of an apparatus employing an embodiment of the present invention and executed by the processor 12, 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by a processor, an audio sample captured by an audio sensor of a mobile device;
determining, by the processor, a context categorization for the mobile device based at least on the audio sample, the context categorization comprising at least one motion state and a vehicle type indicator, wherein determining the context categorization comprises analyzing the audio sample using a classification engine; and
providing, by the processor, the context categorization for the mobile device as input to a crowd-sourcing or positioning process.

2. The method of claim 1, wherein the audio sample is captured by the mobile device responsive to a trigger condition being satisfied.

3. The method of claim 2, wherein the trigger condition is satisfied when at least one of the following occurs:
one or more sensor measurements captured by sensors of the mobile device indicate that GNSS-based measurements are not available;
the context categorization cannot be determined based on inertial sensors;
one or more sensor measurements captured by sensors of the mobile device indicate that one or more crowd-sourcing criteria are satisfied;
one or more sensor measurements captured by sensors of the mobile device indicate that a particular radio device is detected at at least a threshold signal strength for at least a threshold amount of time; or
an indoor positioning estimate is to be performed.

4. The method of claim 1, wherein the processor is one of (a) part of the mobile device, (b) part of a server, or (c) part of a cloud-based processing network.

5. The method of claim 1, wherein one or more parameters of the classification engine were determined using a supervised machine learning process.

6. The method of claim 1, wherein the classification engine is a machine learning trained engine and training data used to train the classification engine comprises a plurality of audio samples associated with corresponding context categorization labels.

7. The method of claim 1, wherein the at least one motion state comprises at least one of (a) a user motion state describing user motion of a user associated with the mobile device or (b) a vehicle motion state indicating a vehicle motion of a vehicle associated with the mobile device.

8. The method of claim 1, wherein the vehicle type indicator is configured to indicate a type of a vehicle with which the mobile device is associated.

9. The method of claim 1, wherein the crowd-sourcing or positioning process is a mobile access point identification process, the mobile access point identification process is configured to:
responsive to determining that one or more observations of an access point by the mobile device satisfy one or more observation criteria and the context categorization for the mobile device comprises a vehicle motion state indicating a vehicle that the mobile device is onboard is moving, determine that the access point is a mobile access point; and
cause an access point registry to be updated to indicate that the access point is a mobile access point.

10. The method of claim 9, wherein responsive to determining the one or more observations of the access point by the mobile device satisfy one or more observation criteria, causing the capturing of the audio sample to be triggered.

11. The method of claim 1, wherein the crowd-sourcing or positioning process is configured to determine a position estimate for the mobile device and determine one or more parameters to be used in determining the position estimate for the mobile device based at least in part on the context categorization for the mobile device.

12. The method of claim 1, wherein the crowd-sourcing or positioning process is configured to determine whether to cause the mobile device to capture and/or provide crowd-sourced information based at least in part on the context categorization for the mobile device.

13. The method of claim 1, wherein the crowd-sourcing or positioning process is configured to generate an indoor positioning map based at least in part on crowd-sourced information captured by one or more sensors of the mobile device.

14. The method of claim 1, wherein the crowd-sourcing or positioning process is configured to determine a user movement pattern for at least one type of vehicle based on crowd-sourced information captured by one or more sensors of the mobile device.

15. The method of claim 1, wherein the classification engine is one of a k-nearest neighbor classifier, a linear classifier, a Bayesian classifier, a decision tree, or a neural network.

16. A method comprising:
obtaining, by a processor, a plurality of audio samples, each audio sample corresponding to a respective context categorization and associated with a respective label indicating the respective context categorization, where the respective context categorization comprises at least one motion state and a vehicle type indicator;
training a classification engine, using a supervised machine learning technique and the plurality of audio samples, to determine a context categorization based on analyzing an audio sample;
at least one of:
providing the classification engine such that a mobile device receives the classification engine, the mobile device configured to use the classification engine to analyze a first audio sample to determine a first context categorization, or
obtaining the first audio sample, determining the first context categorization by analyzing the first audio sample using the classification engine, and providing an indication of the first context categorization.

17. The method of claim 16, wherein the classification engine is one of a k-nearest neighbor classifier, a linear classifier, a Bayesian classifier, a decision tree, or a neural network.

18. The method of claim 16, wherein the at least one motion state comprises at least one of (a) a user motion state describing user motion of a user associated with the mobile device or (b) a vehicle motion state indicating a vehicle motion of a vehicle associated with the mobile device.

19. The method of claim 16, wherein the vehicle type indicator is configured to indicate a type of a vehicle with which the mobile device is associated.

20. An apparatus comprising at least one processor and at least one memory storing computer program instructions, the at least one memory and the computer program code are configured to, with the processor, cause the apparatus to at least:
obtain an audio sample captured by an audio sensor of a mobile device;
determine a context categorization for the mobile device based at least on the audio sample, the context categorization comprising at least one motion state and a vehicle type indicator, wherein determining the context categorization comprises analyzing the audio sample using a classification engine; and
provide the context categorization for the mobile device as input to a crowd-sourcing or positioning process.
